(19) United States
(12) Patent Application Publication
(10) Pub. No.: US 2020/0106600 A1
(43) Pub. Date: Apr. 2, 2020

(54) PROGRESSIVE KEY ENCRYPTION ALGORITHM

(71) Applicant: ZWIPE AS, Oslo (NO)

(72) Inventor: Henry Nardus DREIFUS, Sanford, FL (US)

(21) Appl. No.: 16/617,007

(22) PCT Filed: May 31, 2018
(86) PCT No.: PCT/EP2018/064373

§ 371 Date: Nov. 26, 2019

Related U.S. Application Data
(60) Provisional application No. 62/513,730, filed on Jun. 1, 2017.

(30) Foreign Application Priority Data
Jun. 28, 2017 (GB) 1710329.2

(51) Int. Cl. H04L 9/06; G06F 21/60; H04L 9/30; H04L 9/14; H04L 9/32; H04L 9/08; G06K 9/00

(52) U.S. Cl. CPC H04L 9/065; G06F 21/602; H04L 9/3066; H04L 9/14; H04L 9/3278; G06K 2009/00953; H04L 9/0844; G06K 9/0008; G06K 9/001; G06K 9/00885; H04L 9/3231

(57) ABSTRACT

A method is described for encrypting data that provides increase resistance to brute Identify data segments force attacks by parallel computing means, such as by a quantum computer. To encrypt the data, it is separated into a plurality of data segments, and each of the data segments is encrypted using a different encryption key. The encrypted data segments are then arranged as an encrypted data file in Assign encryption order a manner that impedes parallel attack of the encrypted data segments. For example, the lengths of the encrypted data segments may be non-uniform and/or the spacing of the encrypted data segments within the encrypted data file may be non-uniform. Each encrypted segment may contain a pointer to the next segment, thus permitting an authorised recipient to sequentially decrypt the data file without prior knowledge of the lengths and/or spacings of the encrypted data segments.

The present invention relates to a method of encrypting and decrypting data, and particularly to encryption and decryption of data using different keys for different portions of the data.

The payment industry has always had to securely maintain sensitive customer information, such as bank account numbers, passwords, billing addresses, etc. However, security becomes especially important when considering the shift to online commerce, which requires the transfer of sensitive data over merchant networks or the Internet.

There has been steady progress made towards replacing the credit card's 40-year-old magnetic strip with a specialized, microcontroller-based, semiconductor payment chip, such as the SLE-78 Security Controller by Infineon. This type of chip, when embedded into a plastic carrier card, can be programmed to function as an EMV chip card that features a metallic contact plate and/or an antenna that can be coupled over very short distances to communicate. The microcontroller is designed to be tamper resistant, so that secret information (such as PIN or secret cryptographic keys) can be more safely stored in its memory. This feature underpins the security benefits brought by chip card technology.

Chip based credit cards are small and severely computationally constrained. There is a finite amount of processing power, memory and security logic that can be encapsulated into a small form factor. Further, for cards solely relying upon non-galvanic contact (or contactless) card operations, only low levels of power/energy can be supplied to the card, as the energy is ‘inducted’ via an antenna, thus further constraining the available energy to power the electronics inside the card.

A recent development is the incorporation of biometric sensors into EMV cards. Such a card may be configured to store, transmit, receive and verify the card owner's biometric data (such as a fingerprint or other biometric based template). It is especially important to protect a user's biometric data because biometric identifiers cannot be changed. Thus, should the user's biometric data be obtained by an unauthorised party, they could make use of that data indefinitely.

Typically, secure data has been protected by various algorithmic encryption mechanisms such as the RSA framework, which is commonly used in secure communication. RSA is an asymmetric cryptographic algorithm, meaning that it uses a pair of derived dissimilar keys for encryption and decryption, respectively. Anyone can be given information about one of the two keys—such as a public encryption key and can apply the public key to encrypt a message, but only the possessor of the private decryption key can efficiently decrypt the message in a reasonable amount of time. The power and security of the RSA cryptosystem is based on the premise that the “factoring problem” is hard. That is, decryption of an RSA cyphertext without knowledge of the private decryption key is infeasible because no efficient algorithm yet exists for factoring large numbers.

Today's computing power does make it possible for a very determined hacker to crunch away until the algorithm is exhausted. Further, with the forthcoming introduction of quantum computing (“QC”), some classes of hard-factoring problems increasingly will become vulnerable to compromise, such as factoring RSA keys. It is therefore necessary to anticipate the QC introduction to better protect the sender and recipient against intervention, modification, and forgery of biometric and other data by third parties. This has further implications to protect sensitive personal information—such as the secure storage of sensitive personal information such as a biometric template on a smartcard's platform, transmission of biometric data from a secure data server across a network, and authentication of a stored biometric template against the transmitted data.

Viewed from a first aspect, the present invention provides a method of encrypting data including a plurality of data segments, the method comprising: encrypting each of the data segments to give a plurality of encrypted data segments, wherein a different encryption key is used to encrypt each data segment, and generating an encrypted data file comprising the encrypted data segments, wherein the lengths of the encrypted data segments may be non-uniform and/or the spacing of the encrypted data segments within the encrypted data file may be non-uniform.

In accordance with this method, a large number keys are used to encrypt relatively small segments of data, making the encryption difficult to defeat using brute force attacks. Furthermore, because the lengths of the encrypted data segments vary or the data segments are un-evenly spaced or offset within the encrypted data file, the encrypted data file is resistant to parallel computing attacks, such as by a quantum computer, because the attacker does not know where each encrypted segment begins and/or ends. Hence, attempting to attack the encryption of the file as a whole is difficult because it is necessary to attack many possible successive permutations.

Consequently, the described method allows for very strong encryption that is resistant to massive parallel processing attacks, or alternatively allows equivalently strong encryption to be achieved using a comparatively weak encryption algorithm because of the use of multiple encryption keys and short (variable length) data segments, thus allowing fast processing even on low-power devices.

Preferably, none of the decryption keys corresponding to the encryption keys can be calculated based on a decryption key corresponding to any other of the decryption keys. As a result, should an attacker break the encryption used on one data segment and determine its decryption key, the attacker cannot then determine the decryption key for any subsequent data segment.

Each data segment preferably comprises an indicator for identifying a location and/or a length of the next encrypted data segment within the encrypted data file. The indicator may be a pointer directing to the location and/or a numerical length of the next encrypted data segment. Alternatively, the indicator may include data suitable for deriving the location and/or length, for example in combination with other data or processes known to the encrypting and decrypting parties. Hence, as the data segments are decrypted in order by an authorised recipient, they can immediately access the next data segment on the series. However, as discussed above, an unauthorised recipient of the file does not know where each data segment begins or ends and so cannot easily attack the file as a whole through parallel computing attacks.

The non-uniform spacing of the encrypted data segments may be achieved in various ways. For example, random lengths of random data may be added between data segments such that it is not possible to detect whether a particular piece of data is part of the ciphertext of an encrypted data segment or random data.

Preferably the encrypted data segments are stored within the encrypted data file in a non-consecutive order. Thus, the segments could be in any order, increasing the number of possible permutations available.

The data segments may be encrypted using an encryption algorithm that encrypts and decrypts. The encryption algorithm may be a block cipher, i.e. an encryption algorithm applying an invariant transformation to a fixed-length group of bits, known as a block, that is specified by a key. Exemplary encryption algorithms include, for example, the Advanced Encryption Standard (AES) algorithm and Elliptic Curve Cryptography (ECC) algorithms.

When using a block cipher, the non-uniform data segment length may be achieved, for example, by using a different number of blocks in each segment. Alternatively, it may be possible to use different block lengths for different data segments. It will be appreciated that changing the block length will also require a corresponding change to the key length.

Preferably, each encryption key is generated from a common seed value. Thus, only a single seed value is required to generate all of the encryption keys-(and hence decryption keys for a symmetric-key algorithm). However, an algorithm for generating the encryption keys from the common seed values is preferably not reversible, i.e. such that an attacker finding one of the encryption keys cannot use this to determine the seed value. The seed value may, for example, be a unique code stored in a secure memory of an electronic device, e.g. during manufacture, and/or may be derived by measuring a unique characteristic inherent within a specific electronic device, such as through a physically unclonable function (PUF). A PUF is an inherent behaviour that arises due to the unique characteristics of the micro-defects in the semiconductor integrated circuit.

Each data segment may comprise a message authentication code for verifying the integrity of at least part of the data segment. A message authentication code (MAC) is a short piece of information used to authenticate a message, i.e. to confirm that the message came from the stated sender and has not been changed in transit. A MAC algorithm, accepts as input a secret key and an arbitrary-length message to be authenticated, and outputs a MAC (sometimes known as a tag). There are many possible algorithms to generate a MAC, but it should be computationally infeasible to compute a valid MAC for a given message without knowledge of the key.

The message authentication code may be generated using the encryption key for the respective data segment. In an alternative, the message authentication codes may be generated using secret keys generated based on a seed value for generating the encryption keys. Typically, a message authentication code includes information derived from the message such as a cryptographic hash.

The message authentication code is preferably also suitable for verifying the integrity of at least part of a preceding data segment. For example, the part of the preceding segment includes a message authentication code of the preceding segment. Thus, any tampering to the message is difficult as it further requires recalculation of the subsequent message authentication codes.

The data may comprise biometric data and wherein each data segment represents data defining a discrete number of minutiae of a biometric identifier or a biometric template. In one embodiment, each data segment may represent data defining a single minutia of the biometric identifier or the biometric template. As discussed above, it is crucially important to protect biometric data as a person's biometric identifiers cannot be changed.

The biometric identifier may be a fingerprint, for example. In the case of a fingerprint, the minutia may include any one or more of be a ridge ending, a ridge bifurcation, a short or independent ridge, an island, a ridge enclosure, a spur, a crossover or bridge, a delta, a core. The most common minutiae used today for representation of a fingerprint are ridge endings and ridge bifurcations. Other biometric minutia may include intra-feature geometries or other metrics, which may include 3-dimensional representations of a feature—such as resolved via ultrasonic methods.

Typically a minutiae may be represented by at least a position (e.g. in a Cartesian or radial coordinate system) and a minutia angle. However, the minutia may also or alternatively be represented by defining the positions of neighbouring minutiae in a relative coordinate system. Where the data includes data defining neighbouring minutiae and different minutiae may have a different number of neighbouring minutiae, then the data segments may be naturally of different lengths as a result. In some embodiments, the biometric data may be represented in 3-dimensions.

Viewed from a second aspect, the present invention also provides a method of decrypting an encrypted data file comprising a plurality of encrypted data segments, wherein the lengths of the encrypted data segments are non-uniform and/or the spacing of the encrypted data segments within the encrypted data file is non-uniform, the method comprising: identify a location of first encrypted data segment; decrypting the first encrypted data segment using a decryption key; and for each subsequent encrypted data segment: identify a location of the subsequent encrypted data segment; decrypting the subsequent encrypted data segment using a decryption key different from any decryption key used previously.

The location and/or a length of first encrypted data segment may be known before decrypting the encrypted data file. For example, the location of the first encrypted data segment may be pre-agreed, such as the first bit of the encrypted data file. Alternatively, or additionally, the location of first encrypted data segment may be included with the encrypted data file. For example, the file may include metadata indicating the location of the first data bit. The metadata may be in an unencrypted format, or this may also be encrypted.

Identifying the location and a length of the subsequent encrypted data segment may comprise identifying a location and a length of the subsequent encrypted data segment from an identifier contained in in the preceding data segment. For example, the encrypted data segments may be stored within the encrypted data file in a non-consecutive order.

Alternatively, where the encrypted data segments are stored within the encrypted data file in a consecutive order, the data segment may include an identifier indicating the end of the data segment. Thus, identify a location of the subsequent encrypted data segment may comprise identify the end of the preceding encrypted data segment. This is preferably only possible after decryption; thus an attacker could still not determine the length of each data segment based on the original encrypted data file.

The data segments may be encrypted using an encryption algorithm that encrypts and decrypts data. The data segments may be encrypted using a block cipher encryption algorithm.

Each decryption key may be generated from a common seed value which may be derived from a physically unclonable function (PUF). The common seed value is preferably not included within the encrypted data file. For example, the common seed value may be a pre-agreed secret value or may be exchanged separately from the encrypted data file, for example using public key encryption.

Each data segment may comprise a message authentication code for verifying the integrity of at least part of the data segment. The message authentication code may be also for verifying the integrity of at least part of a preceding data segment. The part of the preceding segment includes a message authentication code of the preceding segment.

The method may further comprise generating a message authentication code for each data segment and comparing the generated message authentication code to the message authentication code from the encrypted data segment.

Viewed another aspect, the present invention may also be seen to comprise a computer program product, or a tangible computer readable medium storing a computer program product, wherein the computer program product comprises computer executable instructions that, when executed by a processor, will cause the processor to perform any of the methods described above, optionally including any of the optional or preferred features described.

The present invention may also be seen to provide an electronic device arranged to perform any one or more of the methods described above, optionally including any of the optional or preferred features described. For example, the electronic device may be adapted to perform both the encryption method and the decryption method.

The electronic device, for example, may be a computing device or may be a smartcard.

Viewed from a third aspect, the present invention also provides an encrypted data file comprising a plurality of encrypted data segments, wherein each encrypted data segment is encrypted with a different encryption key and wherein the lengths of the encrypted data segments are non-uniform and/or the spacing of the encrypted data segments within the encrypted data file is non-uniform.

As discussed above, the proposed encrypted data file is difficult to defeat using brute force attacks and is particularly resistant to parallel computing attacks because the lengths of the encrypted data segments vary and/or the data segments are un-evenly spaced within the encrypted data file, thus meaning that the attacker must either attach the file sequentially or attempt many further permutations to attack the encryption using parallel techniques.

Preferably none of the decryption keys corresponding to the encryption keys can be calculated based on a decryption key corresponding to any other of the encryption keys.

The encrypted data segments may be stored within the encrypted data file in a non-consecutive order. Each data segment may comprise an indicator that identifies a location and/or a length of the next encrypted data segment within the encrypted data file.

The encrypted data segments may be encrypted using an encryption algorithm that encrypts and decrypts data, such as the AES algorithm or an ECC algorithm.

Each data segment may comprise an encrypted message authentication code for verifying the integrity of at least part of the data segment. The message authentication code is also for verifying the integrity of at least part of the data segment of a preceding data segment. The part of the preceding data segment includes a message authentication code of the preceding data segment.

The encrypted data file may contain encrypted biometric data and each data segment may represent data defining a discrete number of minutiae of the biometric identifier. Each data segment may represent data defining a single minutia of the biometric identifier.

It will be appreciated that the encrypted data file may be generated by the method according to the first aspect and may include any features arising from that method or the preferred aspects thereof. Similarly, the encrypted data file may be decryptable by the method according to the second aspect and may include any required for use with that method or the preferred aspects thereof.

Viewed from a further aspect, the present invention provides a data storage element storing an encrypted data file as described above.

The present invention may also provide an electronic device comprising the data storage element. The electronic device may be a smartcard, such as a payment card.

The electronic device is arranged to perform the decryption method as described in the second aspect, optionally including any optional or preferred features thereof.

The encrypted data file may contain encrypted biometric data and wherein each data segment represents data defining a discrete number of minutiae of the biometric identifier and the device may comprise a biometric sensor. The device may be further arranged to compare the decrypted biometric data with biometric data scanned using the biometric sensor.

Certain preferred embodiments of the present invention will now be described in greater detail by way of example only and with reference to the accompanying drawings, which:

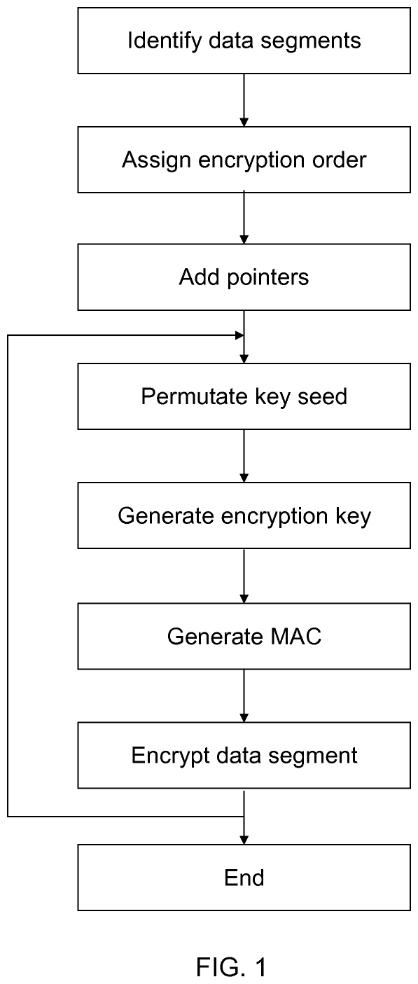

FIG. 1 illustrates the steps of an encryption process;

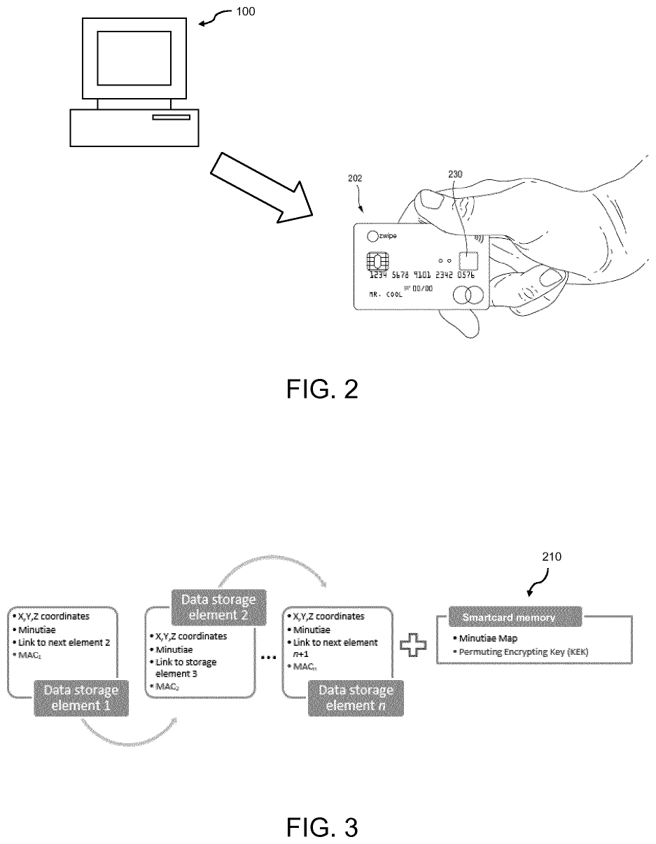

FIG. 2 illustrates a computing device transmitting an encrypted data file to a biometrically-authorised smartcard; and

FIG. 3 illustrates a structure of the received encrypted data file and the associated, secret metadata stored in the secure memory of the smartcard.

The following embodiment describes a parallel-computing-resistant and quantum computing resistant data protection process that divides information across n-dimensions (each representing individual biometric minutiae vectors). The data elements are not stored sequentially, but rather are broken into discrete elements, each with different data attributes from one record to another (including not necessarily fixed length data—such as sectioned biometric information). These records are then protected with a mutating encryption key that varies by a continuous and progressive key transformation.

The encryption uses a continually permuting encryption key (which can be permuted based on various techniques as discussed below) to improve the security along with a message authentication code (MAC) to further assure integrity of the stored information. Unlike a static key (common to all data elements), permuting the encrypting key will increase the difficulty of extraction of the encrypted data because it will better resist brute force attacks as well as parallel computing attacks, including those such as by a quantum computer.

The processing of a plurality of data storage elements of a conventional (prior art) implementation is as follows:
The sender and the receiver agree on a secret key to be used prior to transmitting biometric data. For example, using public key encryption, public key exchange (such as Diffie-Hellman key exchange), or by prior negotiation.
The sender transmits data to the receiver encrypted using the secret key. The sender also generates a message authentication code based on the transmitted data and the secret key, which is also sent to the receiver.
At the other end, the receiver decrypts the data using the secret key.
The receiver wants to make sure that data is received intact at the other end and wants a guarantee that the sender actually sent the data. To do this, the receiver generates a message authentication code based on the received data and the secret key, and compares that value with the message authentication code that was received with the message from the sender.
If the computed value is different from the received value, it can be assumed that the data was tampered with along the way and the smartcard is rendered useless.
If the computed value is the same as the received value, the data can be assumed to have passed the integrity and authentication test.

Achieving a higher level of entropic information protection, analogous to “one-time-key” encryption based approaches, can be accomplished through introducing a mutating, self-validating, progressive key migration process, which adds a computational complexity that is inherently resistive to a QC based exploitation. Applying additionally a permuting encryption key bolsters the protection and adds both entropy and sequential computational imposition to the recreation of the previously encoded minutia map.

Any reproducible function may be used to permute the key, although the function should preferably be at least a non-reversible function. Exemplary techniques for performing the key permutation process may include those known for the generation of one-time passwords. In a preferred embodiment, the key permutation process uses a genetic mutation algorithm. In some embodiments, the key permutation algorithm may permit a length of the generated key to change each time the key is permuted.

Specific examples of suitable genetic mutation algorithm techniques for permutation of a key are found in the following articles:
ARRAG, Sliman, et al., “Replace AES Key Expansion Algorithm by Modified Genetic Algorithm”, Applied Mathematical Sciences, 2013, Vol. 7, no. 144, 7161-7171
DEVI, S. et al., “A Public Key Cryptosystem using ECC and Genetic Algorithm”, International Journal of Engineering Research & Technology, February 2014, Vol. 3, Issue 2

The processing of the plurality of data storage elements in accordance with the illustrated embodiment is implementation is as follows and is shown graphically in FIG. 1.
The sender and the receiver agree on a secret key seed to be used prior to transmitting biometric data. As above, this may be agreed using public key encryption, public key exchange or by prior negotiation. In one embodiment, the secret key seed may be derived from a physically unclonable function (PUF) or other unique, physically-derivable property of a device, such as a smartcard.
The data is then split into a plurality of data segments. For example, in the case of biometric data, each data segment may represent a single minutia. The data segments do not necessarily need to be the same length and optionally random data may be added between data segments to create uneven spacing between the starting bits of each data segment.
Next an encryption order is generated, which is the order in which the data segments will be encrypted. The order is preferably at least non-sequential and may be random or pseudo-random. This order may be generated locally on the encrypting device and does not need to be pre-arranged. However, the recipient should be able to identify the first data segment of the encryption order. For example, a pointer may be included in unencrypted format to identify the first data segment, or the starting data segment may be pre-agreed with the recipient, e.g. the first data segment.
Next, a pointer is added to each of the data segments (except of course the final one), that indicates the next segment in the encryption order.
The data segments are then encrypted, one by one, in the order set out in the encryption order. The encryption process for each segment is as follows:
   The key seed is mutated. For example, the key seed may be modified by a first one-way function.
   Next, an encryption key is generated, for example by using a second, different one-way function on the mutated key seed. By using different one-way functions, a preceding key cannot be used to calculate a subsequent key.
   An optional message authentication coded may be generated and added to the data segment (as will be discussed below).
   The data segment is encrypted using the generated encryption key.

Each data segment thus includes a link to the next segment and is encrypted using a different encryption key calculated from the permutating key seed.

This type of processing is highly resistant to brute force attacks because multiple encryption keys are used and each key encrypts only a relatively small proportion of data. However, the encryption keys can be relatively easily calculated and so do not significantly delay the encrypting and decrypting process.

Furthermore, the processing is particularly resistant to attacks from extremely parallel processing devices, such as a quantum computer. This is because the preceding segments must be decrypted in order to know where the next segment is located within the file. If an unauthorised party were to attempt to forcibly decrypt the entire file, the computing device would not know where each encrypted segment begins and ends and thus the number of possible permutations that would need to be tested would increase significantly.

Optionally, different key lengths and/or different encryption algorithms may be used to encrypt the various data segments. In this case, each data segment may contain an indication of the key length and/or the encryption algorithm to be used for the subsequent data block. In this case, a one-way function used to generate the encryption/decryption key may be selected based on the indicated key length and/or the encryption algorithm, so as to generate an appropriate key.

As discussed above, a message authentication code (MAC) may coexist with the biometric data to add a layer of security. Message authentication is a method used in cryptosystems for verifying the authenticity and integrity of data. The integrity aspects of message authentication are concerned with making sure that data is not modified or altered in any way before reaching its intended recipient, and the authenticity aspect is concerned with making sure that the data originates from the entity that the receiver is expecting it to originate from. Each MAC is linked to the preceding MAC and can be programmed to varying degrees of verification requirements. The MAC may be of variable lengths which provides an additional advantage because the varying length makes the algorithm more difficult to hack by varying the data segment length.

The encrypted data file should include strong error correction protection as corruption of any data segment will render the remainder of the file unreadable.

To decrypt the encrypted data file, the encryption part of the process is performed in reverse, as follows.
The sender and the receiver agree on a secret key seed to be used prior to transmitting biometric data.
The receiver receives an encrypted data file from the sender that has been encrypted as discussed above.
The receiver identifies the first data segment of the encryption order. For example, as discussed above, a pointer may be included in unencrypted format to identify the first data segment, or the starting data segment may be pre-agreed with the sender.
The data segments are then decrypted, one by one, as follows:
   The key seed is mutated. For example, the key seed may be modified by a one-way function.
   Next, the encryption/decryption key is generated, for example by using a different one-way function on the mutated key seed.
   The data segment is decrypted using the generated encryption key.
   Optionally, a message authentication code may be generated and compared to a message authentication code included in the data segment.

The algorithm can be realized with both symmetric and asymmetric algorithms that are well known to be easily implemented in hardware and software, as well as in computationally constrained environments such as a smartcard and offers a good defence against various attack techniques. Both symmetric and asymmetric algorithms are capable of using a permuting key and being quickly and efficiently processed in a smartcard's constrained computing environment. Exemplary encryption algorithms that may be used are discussed below.

Advanced Encryption Standard (“AES”) data encryption, for example, is a mathematically efficient cryptographic algorithm, but its main strength rests in the key length options. The time required to crack an encryption algorithm is directly related to the length of the key used to secure the communication.

AES encrypts and decrypts data in blocks of 128 bits using cryptographic keys of 128-, 192- and 256-bits. There are 10 rounds for 128-bit keys, 12 rounds for 192-bit keys, and 14 rounds for 256-bit keys—a round consists of several processing steps that include substitution, transposition and mixing of the input plaintext and transforms it into the final output of cipher text.

The key-expansion of this algorithm helps to ensure that AES has no weak keys. A weak key is a key that reduces the security of a cipher in a predictable manner. By example, DES is known to have weak keys. Weak keys of DES are those that produce identical round keys for each of the 16 rounds. This sort of a weak key in DES causes all the round keys to become identical, which, in turn, causes the encryption to become self-inverting. That is, plain text encrypted and then encrypted again will lead back to the same plain text. This cannot occur with AES or with Elliptical Curve Cryptography, which explained below.

Elliptical Curve Cryptography (“ECC”) is an efficient encryption algorithm that employs a relatively short encryption key. It is faster and requires less computing power than other first-generation encryption public key algorithms such as RSA making it desirable for low-power and computationally constrained environments. For example, a 160-bit ECC encryption key provides the same security as a 1024-bit RSA encryption key and can be up to 15 times faster, depending on the platform on which it is implemented.

An elliptic curve is represented as a looping line intersecting two axes. ECC is based on properties of a particular type of equation created from the mathematical group derived from points where the line intersects the axes. Multiplying a point on the curve by a number will produce another point on the curve, but it is very difficult to find what number was used, even if you know the original point and the result. Equations based on elliptic curves have a characteristic that is very valuable for cryptography purposes: They are relatively easy to perform but extremely difficult to reverse.

FIG. 2 illustrates an exemplary situation in which the encryption algorithm is used to protect biometric data being transmitted from a computing device 100 to a biometrically-activated smartcard 202.

The smartcard 202 includes an on-board fingerprint sensor 230 and an internal control unit (not shown) for fingerprint verification of a bearer of the smartcard 202. The smartcard 202 may, for example, be an access card or a payment card that permits access or a payment transaction only after verification of the identity of the card bearer. Such devices will be known to those skilled in the art, such as described in WO2016/055665, and specific details will not be set out herein.

In the illustrated embodiment, a biometric template is stored on a central computer 100. The biometric template is composed of data representing a plurality of minutiae of a fingerprint of the user, e.g. ridge endings and ridge bifurcations. Each minutia may be represented, for example, as a coordinate position and a minutia angle. The data representing each minutia may also include data defining the relative positions of other minutiae neighbouring the respective minutia.

When the user is issued a new smartcard 202, it is necessary to embed their biometric template onto the smartcard. The system in WO2016/055665 allows the user to enrol directly onto the smartcard using the on-board fingerprint sensor 230. However, there is a risk that an unauthorised person may intercept and falsely enrol their biometric data. Thus, the user may enrol their biometric data once in a secure location, such as a bank, where their identity can be verified, and this biometric template may be stored on the computing device 100.

To enrol the biometric template onto the smartcard 202, it is therefore necessary to transmit the biometric template to the smartcard 202. Thus, it is desirable to ensure that the template cannot be read or used if it is intercepted. It is therefore necessary to encrypt the biometric template.

Each smartcard 202 is pre-programmed with a unique, secret key. This is stored in a secure memory 210 of the smartcard 202 and also in a secure database of the computer 100.

Before transmission, the biometric template is first encrypted using the technique described above and using the secret key of the smartcard 202 as the encryption key seed. Each data segment used for the encryption represents a single one of the minutiae and the key is permuted for each segment. The resulting encrypted data file is then transmitted from the computing device 100 to the smartcard 202.

As illustrated in FIG. 3, the smartcard memory 210 stores the secret key and this may be used to decrypt the encrypted data file, verify the data file using the MACs, and then reconstruct a minutiae map corresponding to the biometric template within the secure memory 210 of the smartcard 202.

Whilst the above embodiment is described in the context of transmission, it will be appreciated that the described encryption technique may be used also for secure storage of data. For example, in the case of biometric enrolment on the card itself, it is not necessary to transmit the biometric template. Preferably the template is encrypted using an inherent PUF, or equivalent key unique to the device. In this way, even if the encrypted template is obtained, it cannot be used on any other sensor/smartcard.

1. A method of encrypting data including a plurality of data segments, the method comprising:
encrypting each of the data segments to give a plurality of encrypted data segments, wherein a different encryption key is used to encrypt each data segment, and
generating an encrypted data file comprising the encrypted data segments,
wherein the lengths of the encrypted data segments are non-uniform and/or the spacing of the encrypted data segments within the encrypted data file is non-uniform; and
wherein each data segment comprises an indicator that identifies a location and/or a length of the next encrypted data segment within the encrypted data file.

2. A method according to claim 1, wherein none of the decryption keys corresponding to the encryption keys can be calculated based on a decryption key corresponding to any other of the encryption keys.

3. A method according to claim 1 or 2, wherein the encrypted data segments are stored within the encrypted data file in a non-consecutive order.

4. A method according to any preceding claim, wherein the data segments are encrypted using an Elliptic Curve Cryptography (ECC) encryption algorithm.

5. A method according to any preceding claim, wherein each encryption key is generated from a common seed value.

6. A method according to any preceding claim, wherein each encryption key is generated from a derived physically unclonable function (PUF).

7. A method according to any preceding claim, wherein each data segment comprises a message authentication code for verifying the integrity of at least part of the data segment.

8. A method according to claim 7, wherein the message authentication code is also for verifying the integrity of at least part of a preceding data segment.

9. A method according to claim 8, wherein the part of the preceding segment includes a message authentication code of the preceding segment.

10. A method according to any preceding claim, wherein the data comprises biometric data and wherein each data segment represents data defining a discrete number of minutiae of the biometric identifier.

11. A method according to claim 10, wherein each data segment represents data defining a single minutia of the biometric identifier.

12. A method of decrypting an encrypted data file comprising a plurality of encrypted data segments, wherein the lengths of the encrypted data segments are non-uniform and/or the spacing of the encrypted data segments within the encrypted data file is non-uniform, the method comprising:
identify a location of the first encrypted data segment;
decrypting the first encrypted data segment using a decryption key; and
for each subsequent encrypted data segment:
identify a location of the subsequent encrypted data segment based on an indicator contained in the preceding data segment;
decrypting the subsequent encrypted data segment using a decryption key different from any decryption key used previously.

13. A method according to claim 12, wherein the location of the first encrypted data segment is known before decrypting the encrypted data file.

14. A method according to claim 12 or 13, wherein the location of the first encrypted data segment is included with the encrypted data file.

15. A method according to any of claims 12 to 14, wherein the encrypted data segments are stored within the encrypted data file in a non-consecutive order.

16. A method according to any of claims 12 to 15, wherein each decryption key is generated from a common seed value, wherein the common seed value is not included within the encrypted data file.

17. A method according to any of claims 12 to 16, wherein each data segment comprises a message authentication code for verifying the integrity of at least part of the data segment.

18. A method according to claim 17, wherein the message authentication code is also for verifying the integrity of at least part of a preceding data segment.

19. A method according to claim 18, wherein the part of the preceding segment includes a message authentication code of the preceding segment.

20. A method according to claim 17, 18 or 19, further comprising:
generating a message authentication code for each data segment and comparing the generated message authentication code to the message authentication code from the encrypted data segment.

21. A computer program or a tangible computer readable medium storing a computer program, wherein the computer program comprises computer executable instructions that, when executed by a processor, will cause the processor to perform a method according to any preceding claim.

22. An electronic device arranged to perform a method according to any of claims 1 to 11 and/or a method according to any of claims 12 to 20.

23. An encrypted data file comprising a plurality of encrypted data segments, wherein each encrypted data segment is encrypted with a different encryption key, wherein the lengths of the encrypted data segments are non-uniform and/or the spacing of the encrypted data segments within the encrypted data file is non-uniform, and wherein each data segment comprises an indicator that identifies a location and/or a length of the next encrypted data segment within the encrypted data file.

24. An encrypted data file according to claim 23, wherein none of the decryption keys corresponding to the encryption keys can be calculated based on a decryption key corresponding to any other of the encryption keys.

25. An encrypted data file according to claim 23 or 24, wherein the encrypted data segments are stored within the encrypted data file in a non-consecutive order.

26. An encrypted data file according to any of claims 23 to 25, wherein the encrypted data segments are encrypted using an Elliptic Curve Cryptography (ECC) encryption algorithm.

27. An encrypted data file according to any of claims 23 to 26, wherein each data segment comprises an encrypted message authentication code for verifying the integrity of at least part of the data segment.

28. An encrypted data file according to claim 27, wherein the message authentication code is also for verifying the integrity of at least part of the data segment of a preceding data segment.

29. An encrypted data file according to claim 28, wherein the part of the preceding data segment includes a message authentication code of the preceding data segment.

30. An encrypted data file according to any of claims 23 to 29, wherein the encrypted data file contains encrypted biometric data and wherein each data segment represents data defining a discrete number of minutiae of the biometric identifier.

31. An encrypted data file according to claim 30, wherein each data segment represents data defining a single minutia of the biometric identifier.

32. A data storage element storing an encrypted data file according to any of claims 23 to 31.

33. An electronic device comprising a data storage element according to claim 32.

34. An electronic device according to claim 33, wherein the electronic device is a smartcard, and preferably a payment card.

35. An electronic device according to claim 33 or 34, wherein the electronic device is arranged to perform a method according to any of claims 12 to 20.

36. An electronic device according to claim 35, wherein the encrypted data file contains encrypted biometric data and wherein each data segment represents data defining a discrete number of minutiae of the biometric identifier.

37. An electronic device according to claim 36, wherein the device comprises a biometric sensor and is further arranged to compare the decrypted biometric data with biometric data scanned using the biometric sensor.
